(19) United States
(12) Patent Application Publication
(10) Pub. No.: US 2026/0054757 A1
(43) Pub. Date: Feb. 26, 2026

(54) MANUAL AND CONFIGURABLE TRANSPORTATION DEVICE

(71) Applicant: SLED Cooler LLC, Marietta, GA (US)

(72) Inventors: Mark Randall PETTETT, Marietta, GA (US); Ricardo RUIZ, Dallas, GA (US)

(73) Assignee: SLED Cooler LLC, Marietta, GA (US)

(21) Appl. No.: 18/813,986

(22) Filed: Aug. 23, 2024

(51) Int. Cl. B62B 1/20; B62B 1/12; B62B 5/00; B62B 15/00

(52) U.S. Cl. CPC B62B 1/20; B62B 1/125; B62B 15/008; B62B 5/0023

(57) ABSTRACT

A vessel for transporting cargo has a first hull and a second hull that are slidably coupled together to be movable between an extended position and a retracted position that is shorter in length. Wheels are coupled to the vessel. The wheels can contact an underlying surface of the vessel when the vessel is oriented at an acute angle relative to the underlying surface. The wheels are free of contact with the underlying surface when the vessel is parallel or substantially parallel to the underlying surface.

### CROSS-REFERENCE TO RELATED APPLICATION

None.

### BACKGROUND

### Field of the Disclosure

The present disclosure relates in general to manual transportation devices and, in particular, to a manual and reconfigurable transportation device that can slide or roll across terrain.

### Description of the Prior Art

Conventional transportation devices for the manual conveyance of goods are very well known. For example, carts, wagons and ice chests with wheels, and totes that can be dragged across sand or snow are common. Although some conventional solutions are workable, improvements in manual transportation devices continue to be of interest.

### SUMMARY

Embodiments of a system, method and apparatus for a vessel for transporting cargo are disclosed. For example, the vessel can comprise a first hull and a second hull that are slidably coupled together to be movable between an extended position and a retracted position that is shorter in length. Wheels can be coupled to the vessel. The wheels are configured to contact an underlying surface of the vessel when the vessel is oriented at an acute angle relative to the underlying surface. The wheels are configured to be free of contact with the underlying surface when the vessel is parallel or substantially parallel to the underlying surface.

### BRIEF DESCRIPTION OF THE DRAWINGS

Before one or more embodiments are described in detail, one skilled in the art will appreciate that they are not limited in its application to the details of construction, the arrangements of components, and the arrangement of steps set forth in the following detailed description or illustrated in the drawings and descriptions. Rather, they are capable of other embodiments and of being practiced or being carried out in various ways. Also, it is to be understood that the phraseology and terminology used herein is for the purpose of description and should not be regarded as limiting.

FIG. 1 is an isometric view of an embodiment of a vessel in a first position.

FIG. 2 is an isometric view of the vessel in a second position.

FIG. 3 is an isometric view of the vessel in a third position.

FIG. 4A-4C are side views of the vessel in the first, second and third positions, respectively.

FIGS. 5A-5C are top views of the vessel in the first, second and third positions, respectively.

FIG. 6 is a rear view of the vessel.

FIG. 7A is a sectional side view of the vessel, taken along the line 7A-7A of FIG. 5B, showing a locking mechanism prior to locking.

FIG. 7B is a sectional side view of the vessel, taken along the line 7B-7B of FIG. 5B, after the locking mechanism is locked.

FIG. 8A is sectional side view of the vessel, taken along the line 8A-8A of FIG. 5B, prior to engagement.

FIG. 8B is sectional side view of the vessel, taken along the line 8A-8A of FIG. 5B, after engagement.

FIG. 9A is a sectional side view of the vessel, taken along the line 9A-9A of FIG. 5B, showing a tether guide.

FIG. 9B is a sectional side view of the vessel of FIG. 9A, showing a tether extending through the tether guide.

FIG. 10 is a side view of the vessel in a backpack configuration for a person using the tether as shoulder straps.

FIG. 11A is a side view of the vessel showing the tether used to pull the vessel while it is in the retracted position.

FIG. 11B is a side view of the vessel illustrating another configuration for the tether.

FIG. 11C is a side view of the vessel showing the tether used to pull the vessel while it is in the extended position.

FIG. 12A is a side view of the vessel with the tether used to drag the vessel while the wheels are not in contact with the ground.

FIG. 12B is a side view of the vessel with the tether used to roll the vessel while the wheels are in contact with the ground.

FIG. 12C is a side view of the vessel with the tether used to drag the vessel in a reverse direction while the wheels are not in contact with the ground.

FIG. 13 is side view of the vessel of FIG. 12C after a deer hunt.

FIGS. 14A-C are top views of an alternate embodiment of a vessel in different positions and tether configurations.

FIG. 14D is a rear view of the embodiment of FIG. 14A.

### DETAILED DESCRIPTION

Referring to the drawings, the following descriptions of various implementations of the present teachings have been presented for purposes of illustration and description. It is not exhaustive and does not limit the present teachings to the precise form disclosed. Modifications and variations are possible in light of the above teachings or may be acquired from practicing the present teachings.

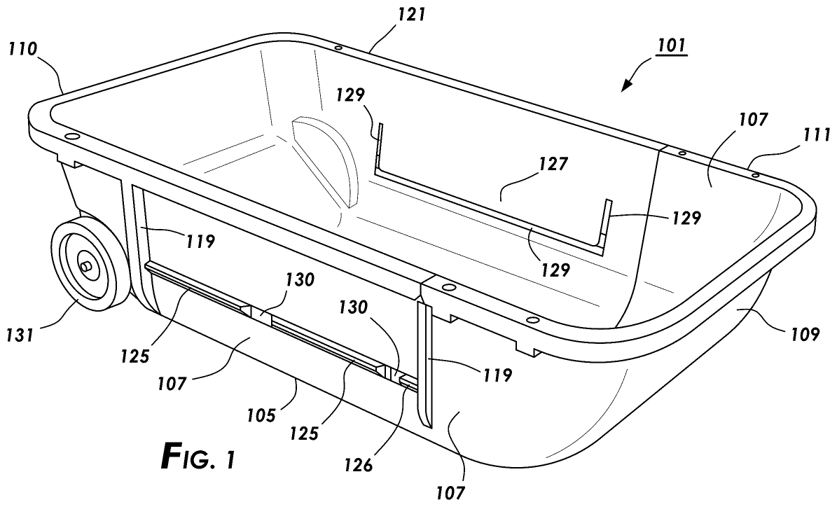

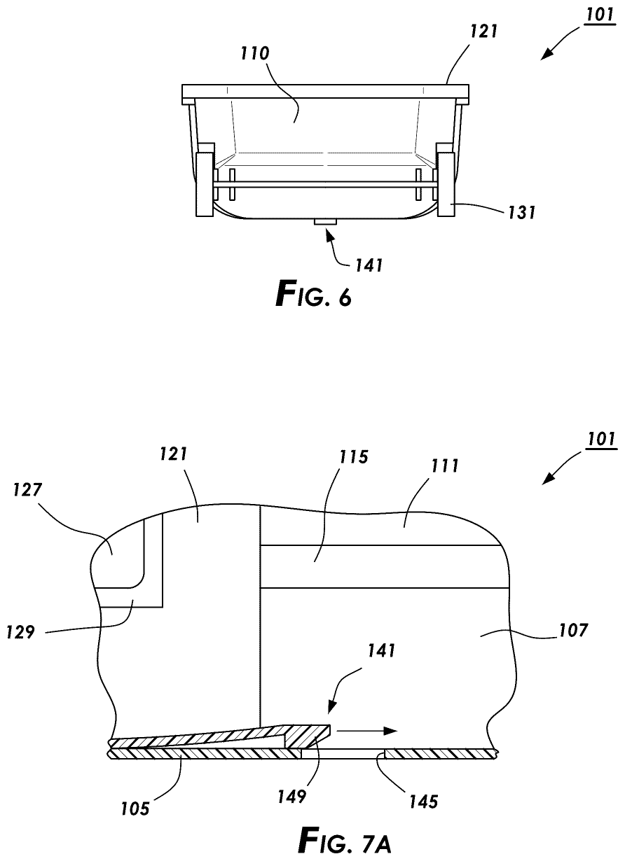

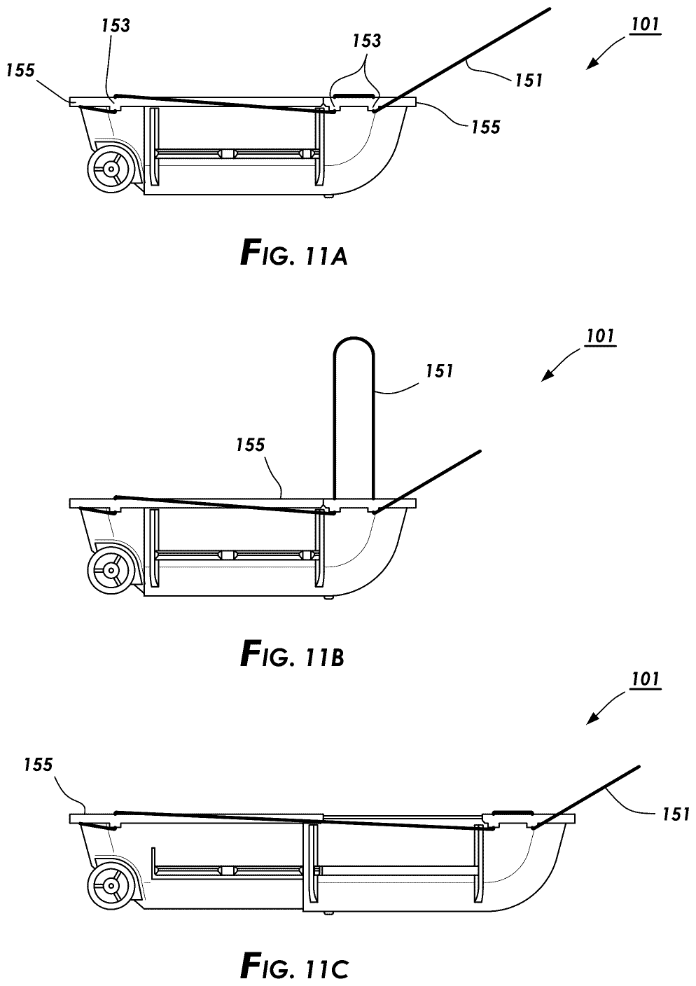

FIGS. 1-14 disclose embodiments of a vessel 101, such as for transporting cargo 103 (FIG. 13). The vessel 101 may comprise at least one of a polymer, carbon composite or carbon fiber, in some versions. The vessel 101 can include a bottom 105, sides 107, front 109 and rear 110. The vessel 101 is open at a top thereof. In an example, the vessel 101 can include a first hull 111 and a second hull 121 that are slidably coupled (e.g., telescopically) together. The first and second hulls 111, 121 can be formed of a same material or different materials. In some versions, the first hull 111 can have a length that is greater than a length of the second hull 121.

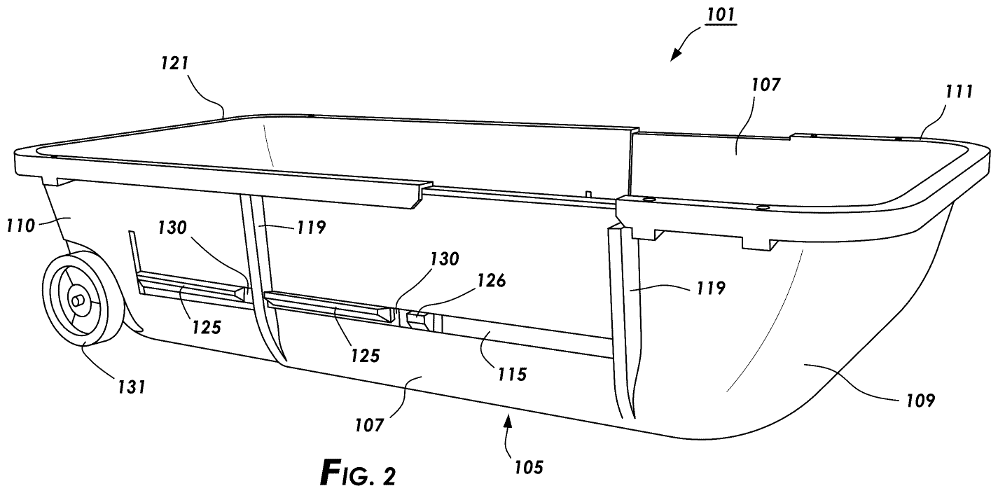

The vessel 101 is reconfigurable for use in a plurality of positions. For example, the plurality of positions can include an extended position (FIGS. 3, 4C and 5C) and a retracted position (FIGS. 1, 4A and 5A). When the vessel 101 is in the retracted position, the vessel 101 is shorter in length than when in the extended position. Thus, the vessel 101 can have a greater cargo volume in the extended position than in the retracted position. In one example, the vessel 101, when in the extended position, is at least twice a length of the vessel 101 when in the retracted position.

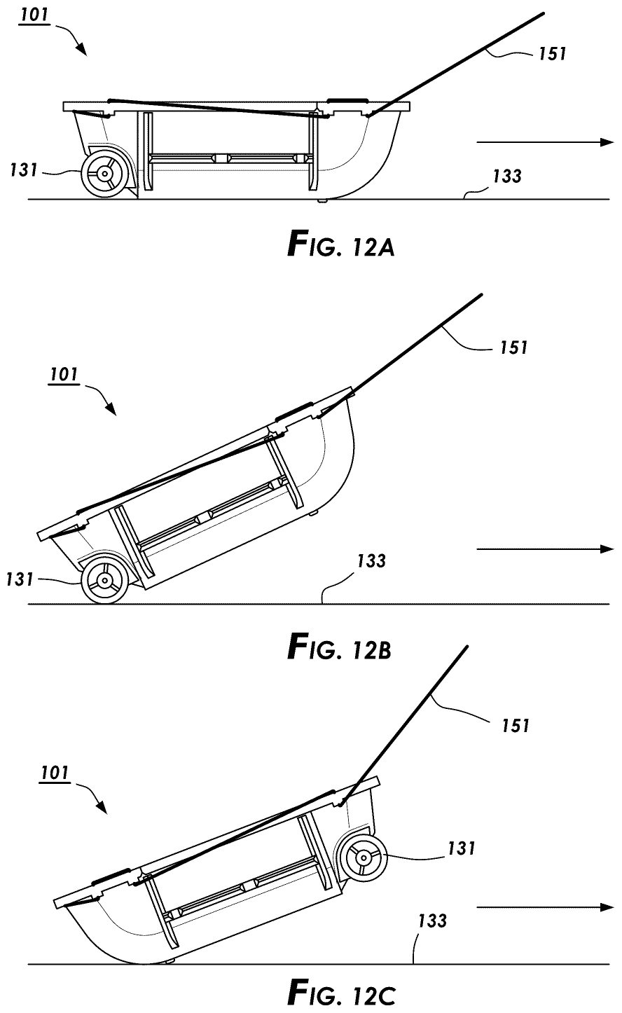

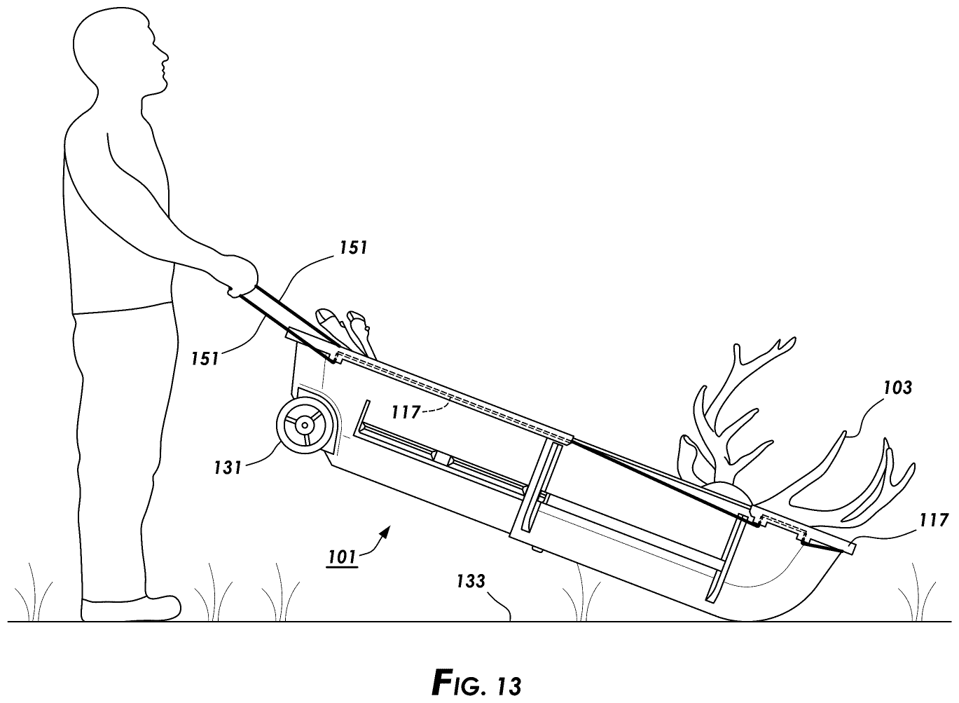

In some embodiments, wheels 131 are coupled to the vessel 101. The wheels 131 are configured to contact an underlying surface 133 (FIG. 12B) when the vessel 101 is oriented at an acute angle with respect to the underlying surface 133. The wheels 131 are free of contact with the underlying surface 133 (FIG. 12A) when a bottom of the vessel 101 is in contact with the underlying surface 133.

Examples of the vessel 101 can further include at least one intermediate position (see, e.g., FIGS. 2, 4B and 5B). In the intermediate position, the vessel 101 is shorter in length with respect to the extended position (FIGS. 3, 4C and 5C), and longer in length with respect to the retracted position (FIGS. 1, 4A and 5A).

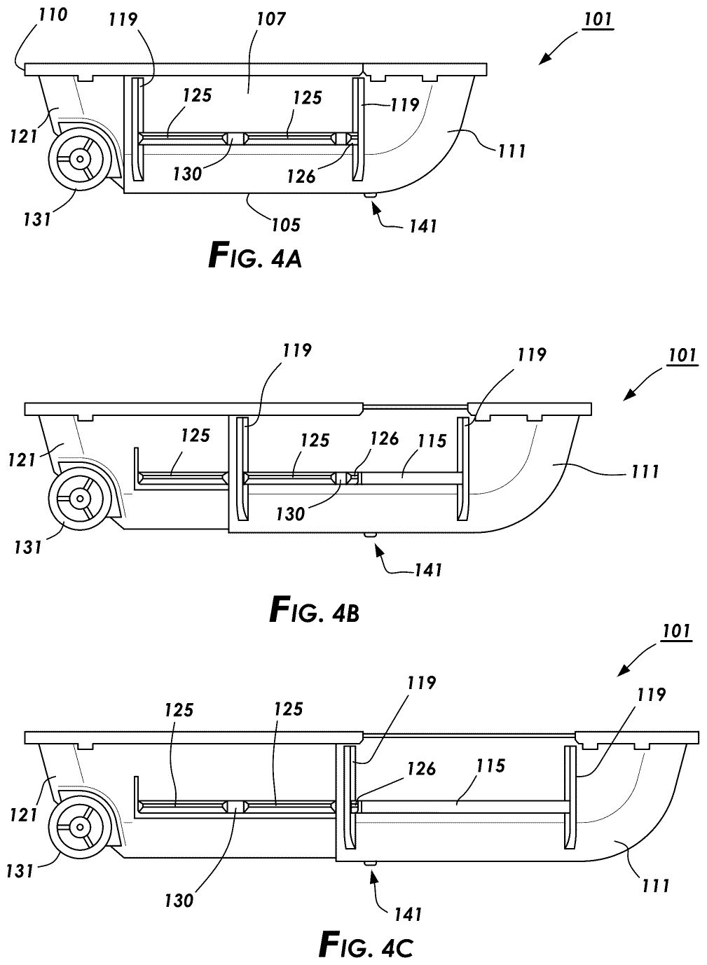

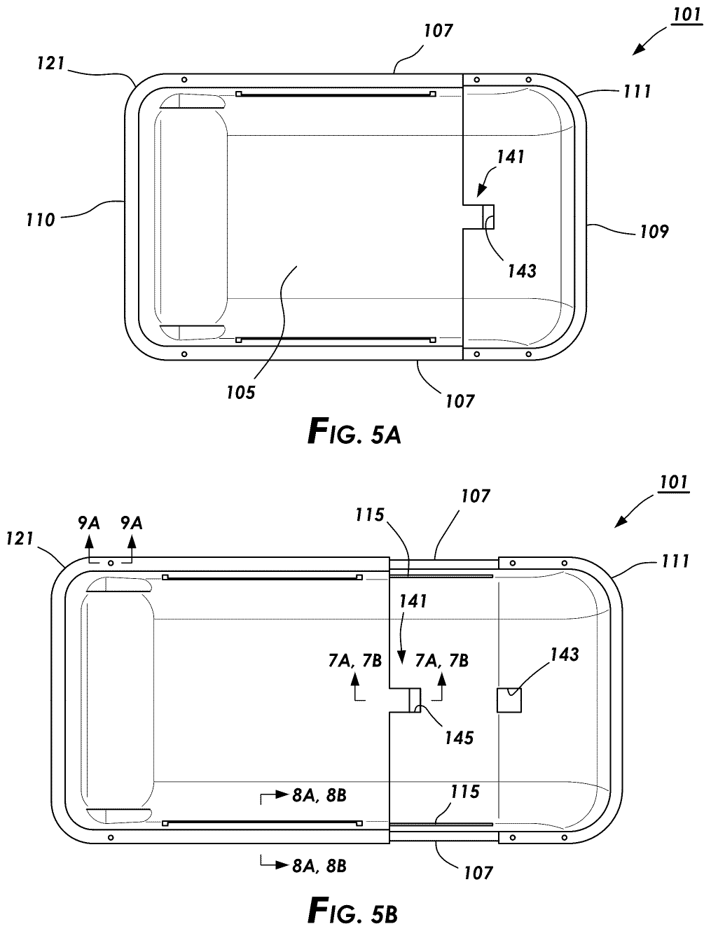

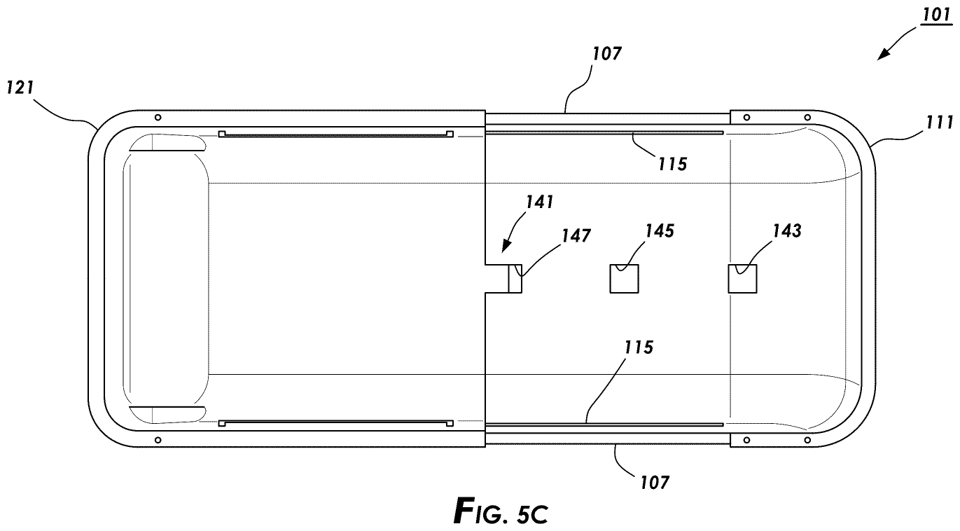

Embodiments of the vessel 101 can include a locking mechanism 141 (FIGS. 5A-5C) to releasably secure the first and second hulls 111, 121 relative to each other in a selected one of the plurality of positions. For example, the locking mechanism 141 can be located at the bottom 105 and comprise openings 143, 145, 147 in one of the first hull 111 and the second hull 121. In the version shown in FIGS. 5A-5C, the openings 143, 145, 147 are in the first hull 111. The openings 143, 145, 147 are arranged to selective engage the locking mechanism 141, which can be a cantilevered tab with a catch 149 (FIG. 7B). In FIGS. 7A and 7B, the locking mechanism 141 is shown prior to and after, respectively, engagement with opening 145. The locking mechanism 141 is flexible so that it can be manually released from the opening 145 to reconfigure the vessel in a different position.

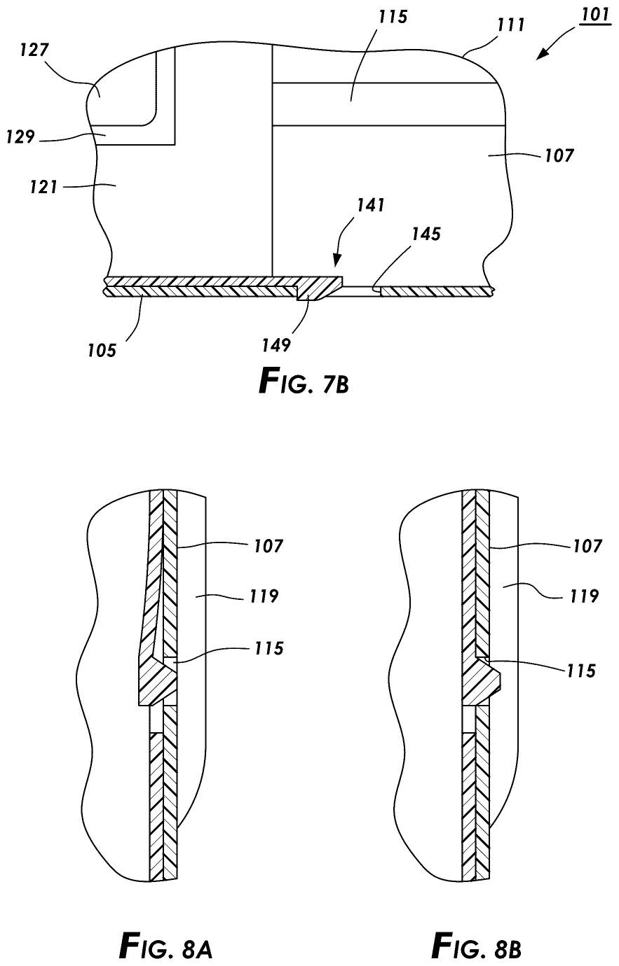

As shown in FIGS. 9-14, embodiments of the vessel 101 can further comprise a flexible tether 151 (e.g., a rope, strap, cord, etc.) coupled to the first and second hulls 111, 121. The flexible tether 151 can extend through guides 153 (FIGS. 9A-9B) in a rim 155 that substantially circumscribes the first and second hulls 111, 121. The vessel 101 can comprise elongated channels 117 (see, e.g., FIG. 13) on sides and ends thereof and a cleat 123. The flexible tether 151 is configured to extend through the elongated channels 117 and coupled to the cleat 123.

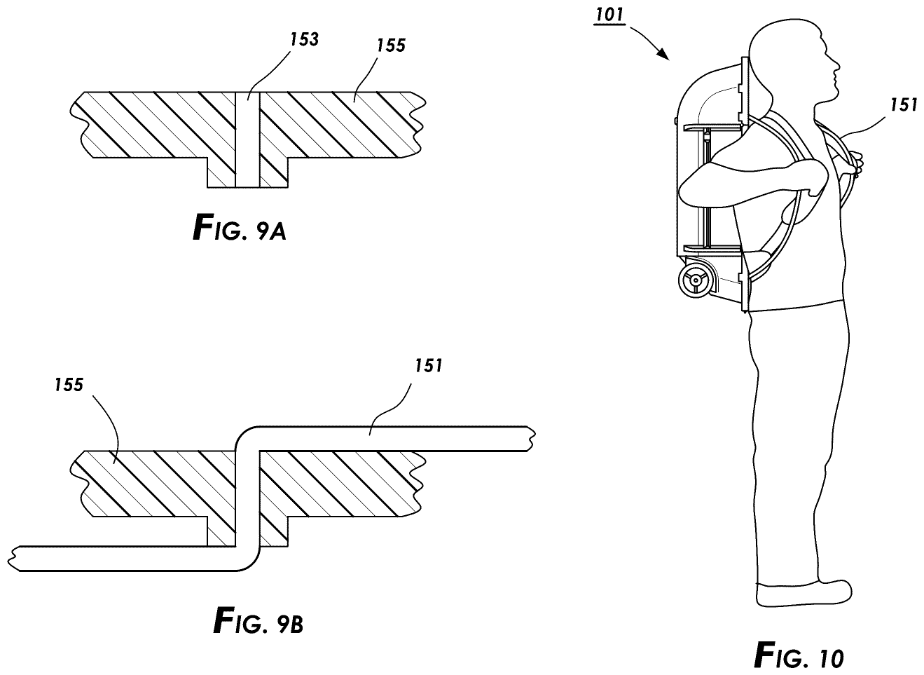

As shown in FIG. 12A, the flexible tether 151 is extendable from the front 109 of the vessel 101 to enable the vessel 101 to be dragged. In FIG. 10, the vessel 101 is in the retracted position so that the flexible tether 151 comprises shoulder straps to enable the vessel 101 to be carried as a backpack on a back of a user, as shown.

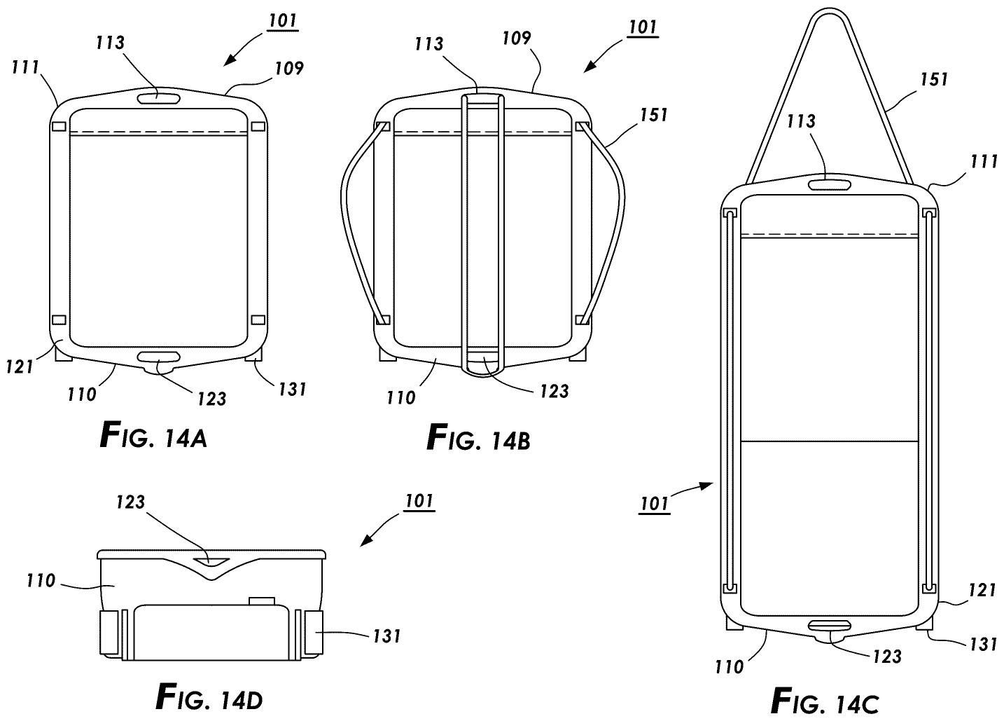

As shown schematically in FIGS. 14A-14D, the first hull 111 can have a rigid handle 113 formed of a same material as the first hull 111. The second hull 121 can have the cleat 123 at the rear 110, and the flexible tether 151 can extend from the front 109 or handle 113 to the cleat 123 and secured by the cleat 123.

Referring again to FIGS. 1-8, the sides 107 of the first hull 111 can have slots 115, which can be horizontal. The second hull 121 can have rails 125 that are complementary in shape to the slots 115, which also can be horizontal. The rails 125 can slidably engage the slots 115 when the vessel 101 is reconfigured in different positions. The rails 125 extend from the second hull 121 on respective flaps 127 (FIGS. 1 and 7). Each flap 127 is flexibly cantilevered from the second hull 121 and surrounded on three sides by horizontal and vertical gaps 129. The flap 127 can be selectively engaged to move rails 125 into and out of slots 115, such that the vessel 101 can move between the extended and retracted positions.

In the embodiments shown, the first hull 111 comprises pillars 119 on an exterior thereof. The pillars 119 can be vertical. The second hull 121 further comprises recesses 130 in its rails 125. In the various positions, the pillars 119 can engage one or more of the recesses 130 to releasably secure the first and second hulls 111, 121.

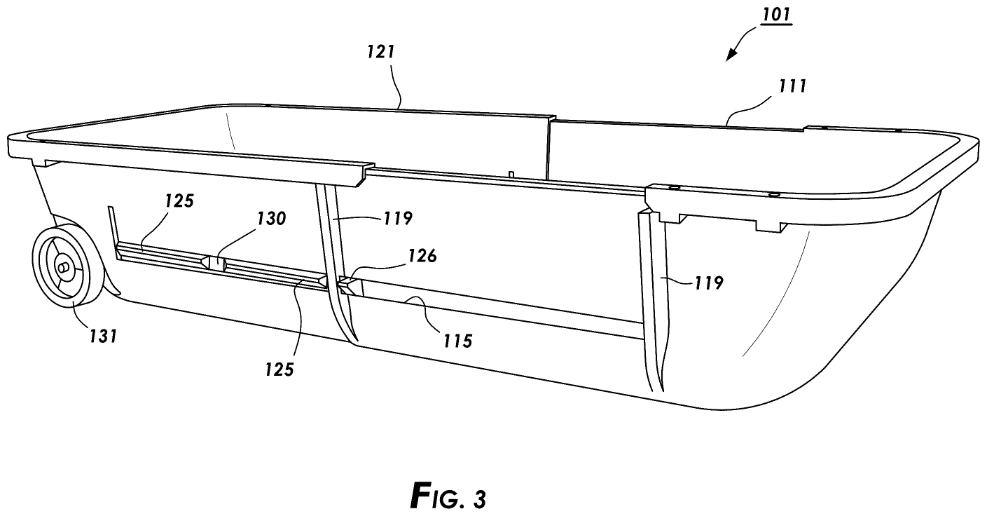

Note that portions of the rails 125 comprise backstops 126 that further help secure the first and second hulls 111, 121 relative to each other in the positions. For example, when the vessel 101 is in the extended position (FIGS. 3 and 4C), the backstops 126 can prevent separation of the first hull 111 from the second hull 121. Working together, the pillars 119, rails 125, backstops 126 and recesses 130 slidably and releasably guide and help secure the vessel 101 in the desired position. These components can have an interference fit such that at least one of the first hull 111 and second hull 121 is elastically deformed to selectively reconfigure the vessel 101 in the different positions.

Other embodiments of a system, method and apparatus for a vessel for transporting cargo can include a first hull (H1) and a second hull (H2) that are slidably coupled together to be movable between an extended position (EP) and a retracted position (RP) that is shorter in length than the EP. Wheels can be coupled to the vessel. The wheels are configured to contact an underlying surface of the vessel when the vessel is oriented at an acute angle relative to the underlying surface. The wheels are configured to be free of contact with the underlying surface when the vessel is parallel or substantially parallel to the underlying surface.

The vessel can be locked in either the EP or the RP. The EP can comprise an extended volume that is greater than a retracted volume of the RP. The vessel can be open and may not comprise a lid to close the open vessel. The vessel can comprise a front, sides, rear and bottom walls, and no top wall such that it is open in both the EP and in the RP. The H1 and H2 can be telescopic relative to each other. The H1 can be larger than the H2 such that, in the RP, at least a portion of the H2 fits inside the H1. The H1 can comprise a rigid handle formed from a same material as the H1, such that the rigid handle is configured to drag the vessel in the EP, and carry the vessel like luggage in the RP. Both the EP and RP can be used for storage and transport of cargo. The H1 and H2 can be formed from a same rigid material comprising a polymer.

The vessel can further comprise a tether, such as a flexible tether. The flexible tether can comprise at least one of a rope, cord, band or elastic band that is coupled to the vessel. The flexible tether can be coupled to both the H1 and the H2. The flexible tether can be configured to extend from a front, rear or sides of the vessel. In the EP, the flexible tether can extend from a front or back of the vessel as a long tether for dragging the vessel. In the RP, the vessel can be configured to be carried as a backpack on a back of a user with the flexible tether configured to be used as shoulder strips by the user. In the RP, the flexible tether can be located in elongated side pockets of the vessel. The flexible tether can be extended from a front of H1 to a cleat at a rear of H2 and secured to the cleat.

The H1 can be tapered at a front thereof to facilitate sliding of the vessel on an underlying surface. The vessel can have a retracted length (RL) in the RP, and the RL can be about half or less of an extended length (EL) of the vessel in the EP. The wheels can consist of only two rear wheels coupled adjacent a rear of the vessel, and no other wheels.

The vessel can further comprise a rim, lip or flange that circumscribes at least a portion of the vessel. The vessel can have a rim that circumscribes an entirety of a top of the vessel in both the EP and in the RP. The rim can be tubular. The rim can comprise a tether track for the tether. Each of the H1 and the H2 can comprise tether slots, and H2 can comprise a tether cleat for a tether when the vessel in is in the RP.

In some versions, the H1 comprises sidewalls with inner slots, and the H2 comprises sidewalls with outer rails that are complementary in shape to the inner slots and slidingly engage the inner slots from the EP to the RP. The inner slots can comprise backstops to prevent separation of the H2 from the H1 when in the EP. The inner slots and outer rails can comprise an interference fit, such that at least one of the H1 and the H2 is elastically deformed to assemble H1 and H2. Embodiments of the H1 can have thicker side walls than the H2 to accommodate the inner slots. The inner slots and outer rails each can comprise twin, parallel features on H1 and H2, respectively.

Embodiments of the wheels can be coupled to H2. H1 can comprise features that are complementary in shape to the wheels and provide relief and separation from the wheels when the vessel is in the RP. A front of H2 can comprise protrusions that are wheel-shaped and engage the features of the H1 in the EP.

Still other embodiments may include one or more of the following items.

1.1 A vessel for transporting cargo, the vessel comprising:
a first hull and a second hull that are slidably coupled together such that the vessel is reconfigurable for use in one of a plurality of positions, wherein the plurality of positions comprises an extended position and a retracted position that is shorter in length than the extended position; and
wheels coupled to the vessel and configured to contact an underlying surface when the vessel is oriented at an acute angle with respect to the underlying surface, and the wheels are configured to be free of contact with the underlying surface when a bottom of the vessel is in contact with the underlying surface.

1.2 The vessel of 1.1, wherein the vessel is further reconfigurable for use in an intermediate position such that the vessel is shorter in length than the extended position and longer in length than the retracted position.

1.3 The vessel of claim 1.2, wherein the vessel is reconfigurable for use in one of a plurality of intermediate positions, wherein the vessel has a respective length in a given one of the plurality of intermediate positions that is different than other ones of the plurality of intermediate positions, and wherein, for each of the intermediate positions, the vessel is longer than the retracted position and shorter than the extended position.

1.4. The vessel of 1.1, wherein one of the first hull and the second hull comprises a locking mechanism to releasably secure the vessel in a selected one of the plurality of positions.

1.5. The vessel of claim 1.4, further comprising an aperture in one of the first hull and the second hull, wherein the aperture is configured to selectively engage the locking mechanism.

1.6 The vessel of 1.1, wherein the vessel further comprises a top, sides, front, and rear, and the top is open, unobstructed and located opposite the bottom.

1.7. the vessel of 1.1, wherein the first hull has a length that is greater than a length of the second hull.

1.8. The vessel of 1.1, wherein the first hull has a rigid handle that comprises a same material as the first hull and is contiguous with the first hull.

1.9. The vessel of 1.1, wherein the first hull and the second hull comprise a same material.

1.10. The vessel of 1.9, wherein the first hull and the second hull comprise a polymer.

1.11. The vessel of 1.9, wherein the first hull and the second hull comprise carbon composite.

1.12. The vessel of 1.9, wherein the first hull and the second hull comprises carbon fiber.

1.13. The vessel of 1.1, further comprising a flexible tether coupled to at least one of the first hull or second hull.

1.14. The vessel of 1.13, wherein the flexible tether is coupled to both of the first hull and the second hull.

1.15. The vessel of 1.13, wherein the flexible tether is coupled to extend from a front, rear, or sides of the vessel.

1.16. The vessel of 1.13, wherein the flexible tether extends through first and second guides on respective sides of the first hull, and the flexible tether extends through third and fourth guides on respective sides of the second hull.

1.17. The vessel of 1.16, wherein the flexible tether is contiguous between the first guide and the second guide.

1.18. The vessel of 1.13, wherein the flexible tether is extendable from a front of the vessel to enable the vessel to be dragged or rolled on the wheels.

1.19. The vessel of 1.13 wherein the vessel, when in the retracted position and using the flexible tether as should straps, is configured to be carried as a backpack by a user.

1.20. The vessel of 1.19, wherein the vessel comprises elongated side pockets on each side of the vessel and a cleat at a rear of the second hull, wherein the flexible tether is configured to be extended from a front of the first hull to the cleat and secured to the cleat.

1.21. The vessel of 1.13, wherein the first and second hulls each comprise respective tether slots to accommodate the flexible tether, and the second hull comprises a cleat for accommodating at least a portion of the flexible tether when the vessel is in the retracted position.

1.22. The vessel of 1.13, wherein a top of the vessel comprises a rim having a tether track for accommodating the flexible tether.

1.23. The vessel of 1.13, wherein the flexible tether is elastic or non-elastic.

1.24. The vessel of 1.13, wherein the flexible tether comprises rope or cord.

1.25. The vessel of 1.1, wherein the first hull comprises a tapered front.

1.26. The vessel of 1.1, further comprising a rim that circumscribes the vessel in each of the plurality of positions.

1.27. The vessel of 1.26, wherein the rim circumscribes an entirety of a top of the vessel in each of the plurality of positions.

1.28. The vessel of 1.26, wherein the rim is tubular in shape.

1.29. The vessel of 1.26, wherein the rim comprises a flange.

1.30. The vessel of 1.1 wherein the vessel, when in the extended position, is at least twice a length of the vessel when in the retracted position.

1.31. The vessel of 1.1, wherein an interior of the vessel comprises a first volume in the extended position and a second volume in the retracted position, and the first volume is greater than the second volume.

1.32. The vessel of claim 31, wherein a top of the vessel opposite of a bottom is open and unobstructed in both the extended and retracted positions.

1.33. The vessel of 1.1, wherein the first hull is larger than the second hull such that, when in the retracted position, at least a portion of the second hull fits inside the first hull.

1.34. The vessel of 1.1, wherein the first hull and the second hull are slidably and reversibly telescopic with respect to each other.

1.35. The vessel of 1.1, wherein a length of the vessel in the retracted position is one half or less than a length of the vessel in the extended position.

1.36. The vessel of 1.1, wherein the wheels of the vessel comprise a first wheel on a first side of the vessel and a second wheel on a second side of the vessel.

1.37. The vessel of 1.36, wherein the first and second wheels are the only wheels on the vessel.

1.38. The vessel of 1.1, wherein the first hull comprises sidewalls with slots, and the second hull comprises side walls with outer rails that are complementary in shape to the slots, respectively, such that the outer rails slidably engage the slots.

1.39. The vessel of 1.38, wherein the vessel comprises backstops that, when the vessel is in the extended position, prevent separation of the first hull from the second hull.

1.40. The vessel of 1.38, wherein the slots and the outer rails comprise an interference fit such that at least one of the first hull and second hull is elastically deformed to assemble the first hull to the second hull.

1.41. The vessel of 1.38, wherein the sidewalls of the first hull are thicker than the sidewalls of the second hull such that the first hull accommodates the inner slots.

1.42. The vessel of 1.38, wherein the slots and the outer rails comprise twin, parallel or mirrored features on the first and second hulls.

1.43. The vessel of 1.1, further comprising a hole that is configured to drain liquid from the vessel.

1.44. The vessel of 1.1, wherein the second hull comprises recesses to accommodate the wheels.

1.45. The vessel of 1.1, wherein the wheels are mounted to the second hull, the first hull comprises features that are complementary in shape to the wheels, and the features provide relief and separation from the wheels when the vessel is in the retracted position.

1.46. The vessel of 1.45, wherein a front portion of the second hull comprises protrusions that are wheel-shaped and engage the features of the first hull when the vessel is in the extended position.

1.47. The vessel of 1.1, wherein the wheels comprise rubber.

1.48. The vessel of 1.1, wherein the wheels comprise polymer.

1.49. An apparatus comprising: a portable container, wherein the portable container includes: a first portion; a second portion slidably coupled to the first portion, wherein the portable container is configurable to be used in a first position in which the portable container is fully extended, and in a second position in which the portable container is fully retracted such that the portable container is shorter in the second position than in the first position; and a plurality of wheels including a first wheel on a first side of the portable container and a second wheel on a second side of the portable container, wherein the wheels are arranged such that they are free of contact of an underlying surface when a bottom portion of the portable container is resting on and in parallel with an underlying surface.

1.50. A cargo transport receptacle comprising: a front portion; and a rear portion slidably and telescopically coupled to the front portion; a locking mechanism configured to lock the cargo transport receptacle in one of a plurality of positions including an extended position and a retracted position, wherein the cargo transport vessel has a greater cargo volume in the extended position than in the retracted position; and first and second wheels attached to first and second sides of the rear portion, respectively, wherein the first and second wheels are arrange such that they are free of contact of an underlying surface when a bottom portion of the cargo transport receptacle is resting on and in parallel with the underlying surface.

1.51. An apparatus comprising: an assembly comprising a first container and a second container slidably coupled together to form a re-configurable cargo holder;
a locking mechanism configured to, when engaged, lock the first and second containers into one of a plurality of positions, the plurality of positions including an extended position and a retracted position, wherein the cargo holder has a larger cargo volume in the extended position than in the retracted position, wherein the locking mechanism is further configured to disengage to enable the slidably coupled first and second containers to change from one of the plurality of positions to another one of the plurality of positions; a first wheel coupled to the second container on a first side of the cargo holder; and a second wheel coupled to the second container on a second side of the cargo holder; wherein the first and second wheels are arranged such that they are not in contact with an underlying surface when a bottom portion of the cargo holder is resting on and in parallel with the underlying surface.

1.52. A cargo carrier comprising: a front portion and a rear portion, wherein the front and rear portions are slidably and telescopically coupled to one another such that the cargo carrier is configurable to be arranged in different ones of a plurality of positions, the plurality of positions including a fully extended position and a fully retracted position, wherein the cargo carrier has a greater length in the fully extended position than in the fully retracted position; a locking mechanism can be engaged to lock the cargo carrier in a selected one of the plurality of positions, wherein the locking mechanism is further disengaged to change the cargo carrier from a current position to a different one of the plurality of positions; and first and second wheels coupled to the rear portion on first and second sides of the cargo carrier, wherein, when a bottom portion of the cargo carrier is in parallel with an resting on an underlying surface, the first and second wheels are not in contact with the underlying surface.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom,” and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

This written description uses examples to disclose the embodiments, including the best mode, and also to enable those of ordinary skill in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

It can be advantageous to set forth definitions of certain words and phrases used throughout this patent document. The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, can mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C.

Also, the use of “a” or “an” is employed to describe elements and components described herein. This is done merely for convenience and to give a general sense of the scope of the invention. This description should be read to include one or at least one and the singular also includes the plural unless it states otherwise.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, sacrosanct or an essential feature of any or all the claims.

After reading the specification, skilled artisans will appreciate that certain features which are, for clarity, described herein in the context of separate embodiments, can also be provided in combination in a single embodiment. Conversely, various features that are, for brevity, described in the context of a single embodiment, can also be provided separately or in any sub-combination. Further, references to values stated in ranges include each and every value within that range.

What is claimed is:

1. A vessel for transporting cargo, the vessel comprising:
a first hull and a second hull that are slidably coupled together such that the vessel is reconfigurable for use in one of a plurality of positions, wherein the plurality of positions includes an extended position and a retracted position, and, when the vessel is in the retracted position, the vessel is shorter in length than when in the extended position; and
wheels coupled to the vessel, wherein the wheels are configured to contact an underlying surface when the vessel is oriented at an acute angle with respect to the underlying surface, and the wheels are configured to be free of contact with the underlying surface when a bottom of the vessel is in contact with the underlying surface.

2. The vessel of claim 1, wherein the vessel is further reconfigurable for use in an intermediate position, wherein, when in the intermediate position, the vessel is shorter in length with respect to the extended position and longer in length with respect to the retracted position.

3. The vessel of claim 2, wherein the vessel is reconfigurable for use in one of a plurality of intermediate positions, wherein the vessel has a respective length in a given one of the plurality of positions that is different than other ones of the plurality of intermediate positions, and, for each of the intermediate positions, the vessel is longer than the retracted position and shorter than the extended position.

4. The vessel of claim 1, further comprising a locking mechanism to releasably secure the first and second hulls relative to each other in a selected one of the plurality of positions.

5. The vessel of claim 4, further comprising openings in one of the first hull and the second hull, wherein the openings are configured to selective engage the locking mechanism.

6. The vessel of claim 1, wherein the vessel includes a bottom, sides, front and rear, and the vessel is open at a top thereof.

7. The vessel of claim 1, wherein the first hull has a length that is greater than a length of the second hull.

8. The vessel of claim 1, wherein the first hull includes a rigid handle formed of a same material as the first hull.

9. The vessel of claim 1, wherein the first hull and the second hull are formed of a same material.

10. A vessel for transporting cargo, the vessel comprising:
a front;
a rear slidably and telescopically coupled to the front;
a locking mechanism configured to lock the vessel in one of a plurality of positions including an extended position and a retracted position, wherein the vessel has a greater cargo volume in the extended position than in the retracted position; and
wheels coupled to the rear, the wheels are configured to be free of contact with an underlying surface when a bottom of the vessel is in contact with the underlying surface, and the wheels are configured to contact the underlying surface when the vessel is at an acute angle relative to the underlying surface.

11. The vessel of claim 10, further comprising a flexible tether coupled to the front and rear.

12. The vessel of claim 11, wherein the flexible tether extends through guides in the front and rear.

13. The vessel of claim 11, wherein the vessel comprises elongated channels on sides thereof and a cleat, and the flexible tether is configured to extend through the elongated channels and coupled to the cleat.

14. The vessel of claim 10 wherein the vessel, when in the extended position, is at least twice a length of the vessel when in the retracted position.

15. The vessel of claim 10, wherein the front comprises sides with slots and the rear comprises rails that are complementary in shape to the slots such that the rails slidably engage the slots.

16. A vessel for carrying cargo, the vessel comprising:
a front and a rear telescopically coupled to each other and configurable in an extended position or in a retracted position, wherein a length of the vessel in the extended position is greater than a length thereof in the retracted position;
a locking mechanism that is selectively engaged to secure the vessel in either the extended or retracted position; and
the vessel comprises flaps that are cantilevered and surrounded on three sides by gaps, and the flaps can be selectively engaged to move the vessel between the extended and retracted positions.

17. The vessel of claim 16, further comprising wheels mounted to the vessel and, when a bottom of the vessel is on an underlying surface, the wheels are not in contact with the underlying surface.

18. The vessel of claim 16, wherein the vessel comprises at least one of a polymer, carbon composite or carbon fiber.

19. The vessel of claim 16, further comprising a flexible tether and a cleat on the vessel, and the cleat is configured to secure the flexible tether.

20. The vessel of claim 19 wherein the flexible tether is, in a first arrangement, extendable from a front of the vessel to enable the vessel to be dragged and, in a second arrangement, when the vessel is in the retracted position, the flexible tether comprises shoulder straps to enable the vessel to be carried as a backpack on a back of a user.
